(19) United States
(12) Patent Application Publication
(10) Pub. No.: US 2013/0232019 A1
(43) Pub. Date: Sep. 5, 2013

(54) FUEL PURCHASE TRANSACTION METHOD AND SYSTEM

(71) Applicant: P97 NETWORKS, INC., Houston, TX (US)

(72) Inventors: Donald J. Frieden, Friendswood, TX (US); Michael W. Coming, Double Oak, TX (US)

(73) Assignee: P97 NETWORKS, INC., Houston, TX (US)

(21) Appl. No.: 13/776,519

(22) Filed: Feb. 25, 2013

Related U.S. Application Data
(60) Provisional application No. 61/602,259, filed on Feb. 23, 2012.

(51) Int. Cl. G06Q 20/20

(52) U.S. Cl. CPC G06Q 20/204
USPC 705/17

(57) ABSTRACT

A mobile device, such as a vehicle telematics system or a smartphone, is used to facilitate a fuel purchase transaction providing a multi-stage authorization process. In a first stage, an account code is provided wirelessly to a fuel station receiver by the mobile device from within the vehicle to prevent using the electrically-powered mobile device at or near the fueling area. The status of the account is checked using a computer. In a second stage, a personal identification number (PIN) corresponding to the account is entered on a display screen/key pad at the fuel dispensing pump proximal to the vehicle to be fueled. The PIN is confirmed to enable the fuel dispensing pump. After fuel is dispensed to the vehicle, the computer debits the account in the amount of the fuel purchase. A software application on the mobile device is used to initiate the fuel purchase transaction.

### STATEMENT OF RELATED APPLICATIONS

This application depends from and claims priority to U.S. Provisional Application No. 61/602,259 filed Feb. 23, 2012.

### FIELD OF THE INVENTION

This invention relates to a method, system for automating payment for fuel purchased at a fuel station. More particularly, this invention relates to a method and system that uses a mobile computing device, such as an integrated vehicle telematics system, a smart tablet or a smart phone, to store and wirelessly provide an account code to a server or to a point of sale system connected to a server at the fuel station.

### BACKGROUND OF THE INVENTION

Point of sale systems and automated payment systems are changing the way consumers pay for goods and services. Retailers such as, for example, fuel stations, often use point of sale systems to process credit and debit card transactions. These systems often provide magnetic strip readers located at the fuel dispensing pumps. Systems and methods have been devised for speeding up electronic commerce (“e-commerce”) including replacing credit cards and debit cards with smart phones used as electronic wallets (“e-wallets”). For e-wallets, software applications or programs installed on the mobile computing device enables the device to rapidly communicate an account number, a credit card number, a debit card number or some other code to another device. These systems enable consumers to purchase goods while eliminating the need to physically present cards on which account, credit or debit codes or numbers are stored, either visibly or magnetically.

Retailers have tested e-wallet transactions using mobile computing devices, such as smart phones, equipped with bar code and/or QR code readers and near-field communications (“NFC”) technology. These technologies have a short “read range” of between 0.5 and 1.5 inches. As a result, these technologies require that the mobile computing device be brought into extremely close proximity to the payment terminal or reader.

For safety reasons, mobile computing devices that operate on electrical current, such as smart tablets, smart phones and other mobile computing devices, should not be used at or near fuel dispensing pumps due to the risk of igniting an explosive vapor and air mixture. A consumer should not be encouraged to use a mobile computing device outside of the vehicle to be fueled or in close proximity to the fuel dispensing pump, whether it is being used to read a bar code or QR code or being placed within the read-range of an NFC reader.

### SUMMARY OF THE INVENTION

Embodiments of the present invention provide a safer and more convenient system and method to use for automating the payment process for purchasing fuel, and are compatible with existing components used in point of sale payment systems. Embodiments of the present invention provide an automated or substantially automated fuel payment system and method that enables a vehicle operator or passenger to initiate a fuel payment transaction using an electrically-powered mobile computing device from within a motor vehicle. A mobile computing device may be an integrated vehicle telematics system or the mobile computing device may be a smart phone, such as a Galaxy® or an iPhone®, a smart tablet, such as an iPad® or a personal digital assistant. The mobile computing device is used to wirelessly provide an account code to a server at the fuel station or to a point of sale system in a frontcourt of the fuel station prior to exiting the vehicle to commence fueling of the vehicle. In one embodiment, the mobile computing device wirelessly provides an account code to a point of sale system, having a wireless receiver in the frontcourt of the fuel station, immediately upon the mobile computing device being brought within a fueling proximity with a fuel dispensing pump. In a related embodiment, the fuel station frontcourt is equipped with a point of sale system comprising a plurality of wireless signal receivers that can be used to indicate the fuel dispensing pump that is nearest to the mobile computing device. In another embodiment, the mobile computing device wirelessly provides an account code through a cellular telephone communications tower proximal to the fuel station to a web-based server, and the web-based server determines the status of an account corresponding to the account code and sends a signal to the fuel station server authorizing the fuel purchase transaction.

In one embodiment of the method and system of the present invention, a software application, also called an “app,” can be downloaded to a mobile computing device. The installed software application may include computer program product code, or a portion of computer program product code, to manage human-machine interface and to control certain multimedia elements used in such human-machine interface. These multimedia elements may include a computer-synthesized voice program to communicate queries to the user of the mobile computing device (e.g., the vehicle operator or a passenger) or to communicate instructions or information from the mobile computing device to the user of the mobile computing device, and/or the multimedia elements may include a speech recognition and interpretation program to receive and interpret vocalized responses, instructions, choices, selections or input from the user to the mobile computing device. These software applications and computer programs may be downloaded and integrated with wireless communications programs and software installed by the manufacturer on the mobile device. For example, these software applications and computer programs may be integrated with wireless fidelity (“Wi-Fi”) applications and programs that control and operate, for example, a transmitter of the mobile computing device to be used for sending wireless signals from the mobile computing device and a receiver for receiving wireless signals to the mobile computing device. The signals sent from the transmitter of the mobile computing device may be, in a first mode, signals sent to a cellular telephone communications tower proximal to the fuel station or, in a second mode, signals sent to a wireless signal receiver of the point of sale system in a frontcourt of the fuel station.

In one embodiment of the method and system, a fuel station server receives signals from and sends signals to the mobile computing device in the motor vehicle through an Internet connection provided to the mobile computing device through distributed cellular telephone communications towers. For example, but not by way of limitation, the fuel station server, and the point of sale system in the frontcourt of the fuel station and connected through a fuel station network to the server, is connected to the Internet through either a wireless connection (e.g., via satellite dish) or a wired connection (telephone wires, television cables, etc.). A fuel purchase account code (hereinafter “account code”) stored on a readable memory on the mobile computing device may be retrieved by a processor of the mobile computing device and wirelessly communicated, using a transmitter of the mobile computing device, to one or more cellular telephone communications towers proximal to the fuel station and relayed to the Internet. The account code is thereby lodged on a web-based server connected to the Internet. Alternately, an account code stored on a readable memory on the mobile computing device may be retrieved by a processor of the mobile computing device and wirelessly communicated, using a transmitter of the mobile computing device, to a wireless signal receiver of a point of sale system in the frontcourt of the fuel station, and relayed therefrom to a fuel station server that, in turn, relays the account code to a web-based server via the Internet. It will be understood that mobile computing devices generally have a transmitter and a receiver to facilitate uploading and downloading data to and from the Internet using, for example, wireless fidelity (“Wi-Fi”) connections or “Wi-Fi hotspots” or using cellular telephone communications towers and related systems.

In an embodiment of the system and method using a point of sale system in the frontcourt of the fuel station to receive signals directly from and send signals directly to the mobile computing device in the motor vehicle using a Wi-Fi system operating within the point of sale system at the fuel station, signals and data can be relayed through the point of sale system and a fuel station network to a fuel station server that is generally maintained remotely from the fueling environment near the fuel dispensing pump.

Both the direct and indirect links between the fuel station server and the mobile computing device involve the use of a data communications link between the mobile computing device and the fuel station server, and the data communications link comprises wireless communication between the mobile computing device and at least one of the Internet and the point of sale system in the frontcourt of the fuel station.

In the embodiment of the system and method that uses a wireless data communications link between the mobile computing device in the motor vehicle and the Internet, a software application is downloaded and embedded into the mobile computing device to enable the mobile computing device to connect, via cellular telephone communication towers, to a mobile network operator such as, for example, AT&T®, Verizon®, T-Mobile® or Sprint®, and to thereby establish a secure data communication network connection over the Internet.

Alternately, the software application downloaded and embedded on the mobile computing device enables the mobile computing device to directly connect to a mobile network operator. This alternate connection between the mobile computing device and the point of sale system also establishes a secure data communication network connection. In either system, an account code is communicated to a commerce infrastructure. Whether the mobile computing device is connected to the fuel station server indirectly via the Internet or directly through a mobile network operator, the present invention provides a secure method of providing an account code stored on a readable memory of the mobile computing device to a server operated by the fuel station operator to enable the status of the account corresponding to the account code to be determined and to initiate the process of authorizing the fuel purchase transaction.

In order to prevent an unauthorized use of the mobile computing device, embodiments of the method and system of the present invention require the entry on a display screen/key pad at the fuel dispensing pump of a personal identification number (PIN) corresponding to the account code stored on the readable memory of the mobile computing device. The PIN is received at the fuel station server through the fuel station network and compared to a recorded PIN accessible by the server. If the PIN entered into the display screen/key pad matches the PIN provided to the fuel station server, the second stage of authorization is completed and the fuel dispensing pump is enabled.

### BRIEF DESCRIPTION OF THE DRAWINGS

The accompanying drawings are provided to illustrate embodiments of the present invention.

FIG. 1 is an elevation view of a fuel station equipped to implement an embodiment of the method and system of the present invention.

FIG. 2 is a drawing illustrating equipment that can be used to implement an embodiment of the method and system of the present invention.

FIG. 3 is a drawing illustrating a display screen/key pad that can be used in implementing an embodiment of the method and system of the present invention.

FIG. 4 is a high level flowchart illustrating an embodiment of a method and system of the present invention for enabling a fuel purchase transaction.

FIG. 5 is a high level flowchart illustrating another embodiment of a method and system of the present invention for enabling a fuel purchase transaction.

FIG. 6 is a diagram of an exemplary computing node that may be utilized in accordance with one or more embodiments of the method and system of the present invention.

### DETAILED DESCRIPTION OF A PREFERRED EMBODIMENT

The term “vehicle telematics system,” as used herein, means a mobile computing device that includes the integrated use of telecommunications, informatics and a human-machine interface control program to control certain multimedia elements within a motor vehicle. Some vehicle telematics systems include a visual display screen in the vehicle, which may be touch sensitive, a speech recognition and interpretation program to facilitate human to machine interaction, and a speech synthesis program to facilitate machine to human interaction. A vehicle telematics system may integrate with a mobile computing device, including a smart phone, cell phone, a mobile phone, a smart tablet, smart pad, a personal digital assistant or other portable computing device which has a software application installed thereon. The integration of these devices and systems may be through wireless (e.g., BlueTooth®) or wired (e.g., using an adapter or universal serial bus (“USB”) cable) connection method to provide communication and cooperation between the mobile computing device and the vehicle telematics system.

Embodiments of the present invention may comprise the use of an account code to identify an account with the fuel station operator or with an intermediary or third party such as, for example, Visa®, Mastercard®, American Express®, Paypal®, a bank or other financial institution. The account code may be stored on a readable memory of the mobile computing device. Embodiments of the present invention may comprise a method and system to use the computing power of a mobile computing device to create a secure session with a web-server, which may be a cloud-based web server, interconnected with the fuel station server 13. For example, the mobile computing device may have a touch-sensitive screen for selecting and activating a software application that retrieves an account code from a readable memory of the mobile computing device, and for wirelessly sending a signal providing the retrieved account code to a web-based server through the Internet. It will be understood that the computing power of the mobile computing device may be used to encrypt the account code for security purposes, and the web-based server or fuel station server may provide computing power for decrypting the account code.

In one embodiment of the method and system of the present invention, the use of the mobile computing device 19 to retrieve and to wirelessly transmit the account code to the fuel station server 13 or to the web-based server 22 may be the first transmission of the fuel purchase transaction, and is used to initiate the authentication process. Alternately, in another embodiment of the method and system of the present invention, the mobile device may initially generate a “greet” signal that can be detected and acknowledged by the fuel station server 13 or the web-based server 22 to create a “handshake” or transactional connection between the mobile computing device 19 and the point of sale system 20 or fuel station server 13 or the web-based server 22, following which the account code may be retrieved and wirelessly provided. In this embodiment, the fuel station server 13 or the web-based server 22 may generate a response signal to the mobile computing device 19 to initiate the session between the mobile computing device 19 and the fuel station server 13 or the web-based server 22 and/or the point of sale system 20. The use of the mobile computing device 19 to initiate a fuel purchase transaction occurs within the vehicle 12 so that the battery-powered mobile computing device 19 is not operated in the presence of fuel vapors in the fueling environment.

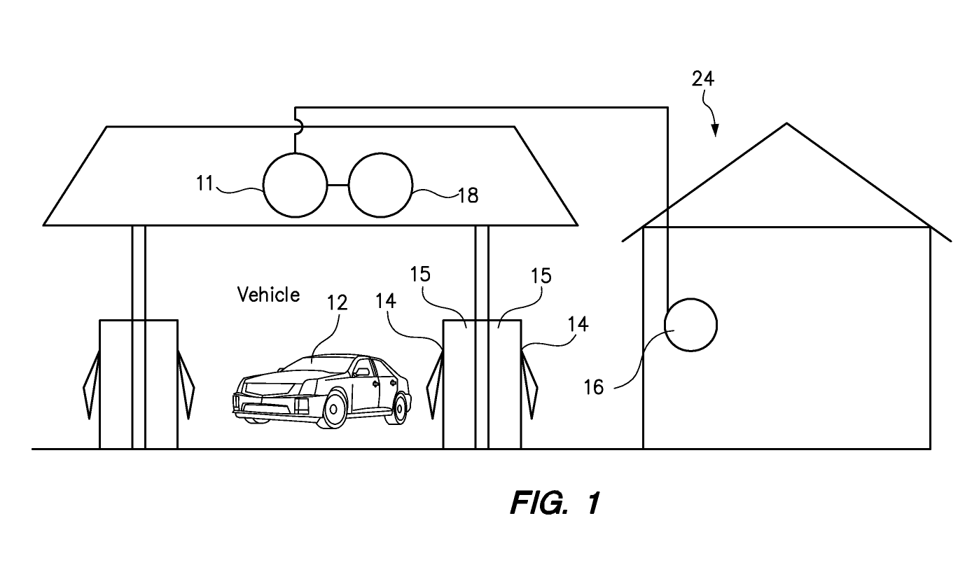

FIG. 1 is an elevation view of a fuel station equipped to implement an embodiment of the method and system of the present invention. A motor vehicle 12 moves to a position proximal to a fuel dispensing pump 15 having a display screen/keypad 14. The fuel station is equipped with a wireless signal receiver 18 and a fuel station network 11 that connects the wireless signal receiver 18 to the fuel station server 16. It will be understood that the server 16 is an electrically-powered device that is housed within a building 24 at the fuel station that is not immediately adjacent to the fuel dispensing pump 15 or to the fueling environment that surrounds the pump 15.

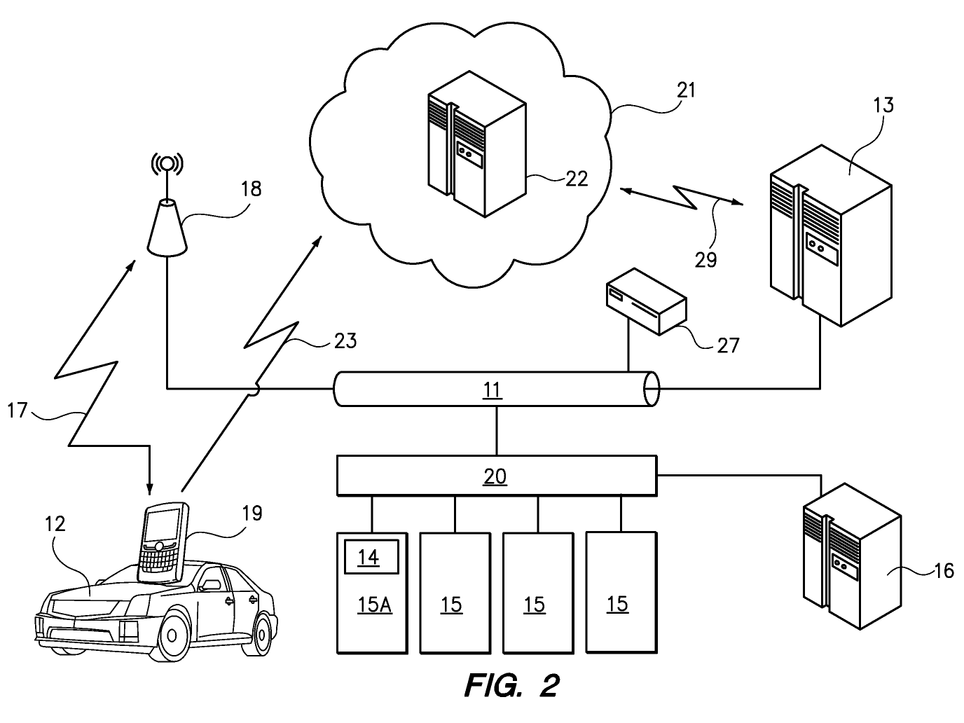

FIG. 2 is a drawing illustrating equipment that can be used to implement an embodiment of the method and system of the present invention. A mobile computing device 19, which may be a vehicle telematics system or a smart phone, is contained within the motor vehicle 12. The mobile computing device 19 may automatically initiate the fuel purchase transaction by wirelessly sending a signal 17 corresponding to an account code retrieved from a readable memory of the mobile computing device 19 to the wireless signal receiver 18 connected, through the fuel station network 11, with a fuel station server 13. In one embodiment of the method and system, the fuel station server 13 may periodically receive, from a web-based server 22 and through the Internet 21, a database of account codes and associated personal identification numbers for accounts authorized to participate in the automated fuel purchase program. In this embodiment, the fuel station server 13 would be able to authorize fuel purchase transactions without communicating with the web-based server 22 for each transaction.

In another embodiment of the method and system, the fuel station server 13 receives the signal 17 corresponding to the account code and sends a signal 29 corresponding to the account code to the web-based server 22 through the Internet 21. The web-based server 22 queries the status of the account corresponding to the account code and then responds through the Internet 21 with a signal 29 back to the fuel station server 13 providing the status of the account corresponding to the account code. Upon receiving a signal 29 indicating that the account code is associated with an account having a satisfactory status, the fuel station server 13 sends a signal through the fuel station network 11 to the fuel dispensing pump 15A adjacent to the motor vehicle 12 with instructions to the site controller 27 or to the point of sale system 20 to display, on the display screen/key pad 14, a request for the entry of a personal identification number associated with the account code.

It will be understood that devices can be provided to automatically indicate the fuel dispensing pump 15A most proximal to the motor vehicle 12 from which the signal 17 from the mobile computing device 19 originated. For example, but not by way of limitation, a plurality of wireless signal receivers 18 can be arranged about the fuel station so that a variance in wireless signal strength among the receivers 18 can be detected to indicate, by the strongest signal, the fuel dispensing pump 15A proximal to the vehicle 12.

In one embodiment of the method and system of the present invention, the operator or a passenger of the vehicle 12 may emerge from the vehicle 12 to the nearest fuel dispensing pump 15 and, using the display screen/key pad 14, enter a personal identification number (PIN) that corresponds to the account code wirelessly provided to the wireless signal receiver 18 through signal 17. Upon receiving and verifying the PIN from the display screen/key pad 14 at the fuel dispensing pump 15A proximal to the vehicle 12, the fuel station server 13 sends a signal through the fuel station network 11 and the site controller 27 or the point of sale system 20 to activate the fuel dispensing pump 15A proximal to the vehicle 12 and associated with the display screen/key pad 14 from which the personal identification code corresponding to the account code was entered. In one embodiment of the present invention, in lieu of a plurality of wireless signal receivers 18 or some other process for determining the fuel dispensing pump 15A nearest to the vehicle 12, the fuel station server 13 may simply activate the fuel dispensing pump 15A that is associated with the display screen/key pad 14 used to enter the PIN corresponding to the account code that is received and for which the status of the related account is checked. In this embodiment, there is no need to employ a system for determining which fuel dispensing pump 15A is nearest to the vehicle 12 since the fuel dispensing pump 15A associated with the display screen/key pad 14 used to enter the PIN will be activated after the PIN is accepted.

The use of the display screen/key pad 14 to enable the operator or a passenger from the vehicle to enter a PIN corresponding to the account code provides, in one embodiment of the method and system, an additional measure of authentication to protect the account owner. The PIN is entered at the display screen/key pad 14 and communicated through the site controller 27 or point of sale system 20 and the fuel station network 11 to the fuel station server 13. For example, but not by way of limitation, the fuel station server 13 may receive a signal 29 from the Internet 21 in the form of the PIN that corresponds to the account code wirelessly provided to the fuel station server 13 by the mobile computing device 19 and through the signal 17, the wireless signal receiver 18 and the fuel station network 11. In this embodiment of the method and system, the entry of a PIN at the display screen/key pad 14 that matches the PIN received from the Internet 21 in response to the query for the status of the account corresponding to the account code and results in enablement of the fuel dispensing pump 15A proximal to the vehicle 12. In another example, the fuel station server 13 may communicate with the web-based server 22 through the Internet 21 twice during the course of authorizing the fuel purchase transaction; that is, the fuel station server 13 may query a web-based server 22 via the Internet 21 for the status of the account corresponding to the account code received by the fuel station server 13 from the mobile computing device 19, via the signal 17, the wireless signal receiver 18 and the fuel station network 11 and then, after receiving a response signal 29 from the web-based server 22 indicating a satisfactory status of the account, and also after receiving a PIN entered at the display screen/key pad 14, the fuel station server 13 may again query the web-based server 22 via the Internet 21 to verify the PIN entered at the display screen/key pad 14. After receiving the PIN provided from the web-based server 22, the fuel station server 13 compares the PIN entered at the display screen/key pad 14 with the verifying PIN provided by the web-based server 22 and, if the PIN received from the display screen/key pad 14 matches the PIN provided by the web-based server 22, the fuel station server 13 will enable the fuel purchase transaction by sending a signal activating the fuel dispensing pump 15A.

It will be understood that the fuel dispensing pumps 15, the display screen/key pad 14 and other components near the proximity of the fuel dispensing pumps 15 are generally explosion-proof components that can be safely operated in the fuel dispensing area, and that the method and system of the present invention provides a safe process for wirelessly identifying the account of the operator or passenger of the vehicle 12 and for obtain the PIN associated with the account to enable the fuel purchase transaction.

It will be understood that the fuel station network 11 interaction with the wireless signal receiver 18 and the fuel station server 13 may, in one embodiment, be monitored or managed using a site controller 27 and that the point of sale system 20, which controls and enables the fuel dispensing pumps 15 and manages messages displayed on or personal identification numbers received from the display screen/key pad 14, may be managed by a point of sale system processor or controller 16.

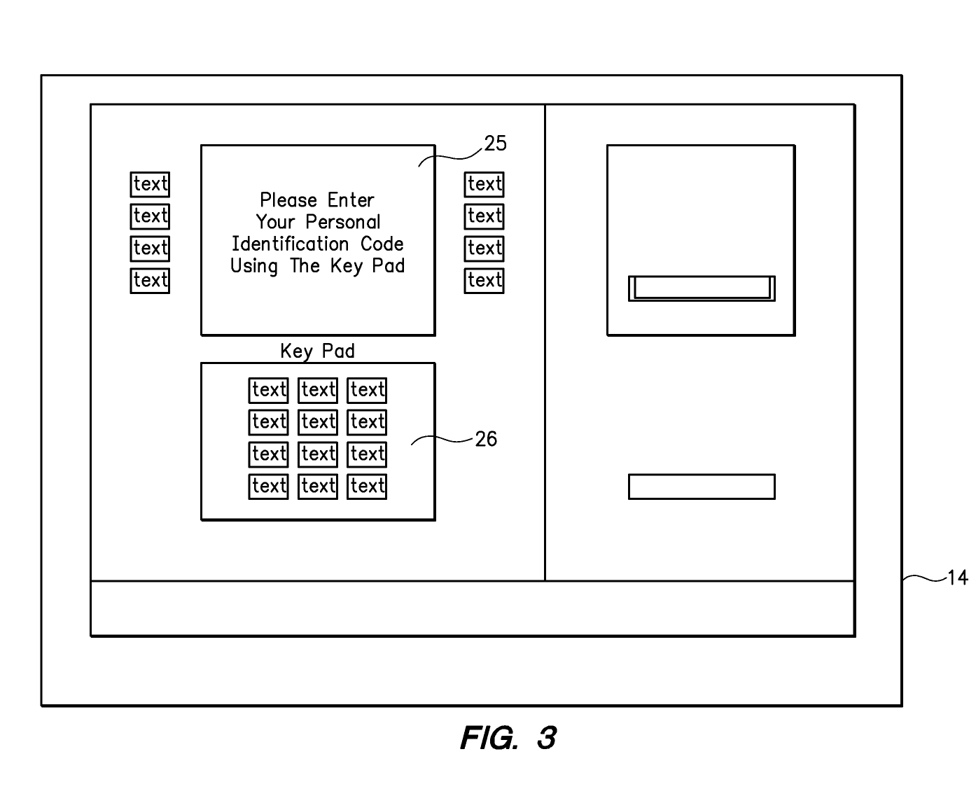

FIG. 3 is a drawing illustrating a display screen/key pad 14 that can be used in implementing an embodiment of the method and system of the present invention. The display screen/key pad 14 comprises a display screen 25 and a key pad 26. The display screen 25 may comprise liquid crystal display, light emitting diode, a cathode ray tube or a plasma screen display.

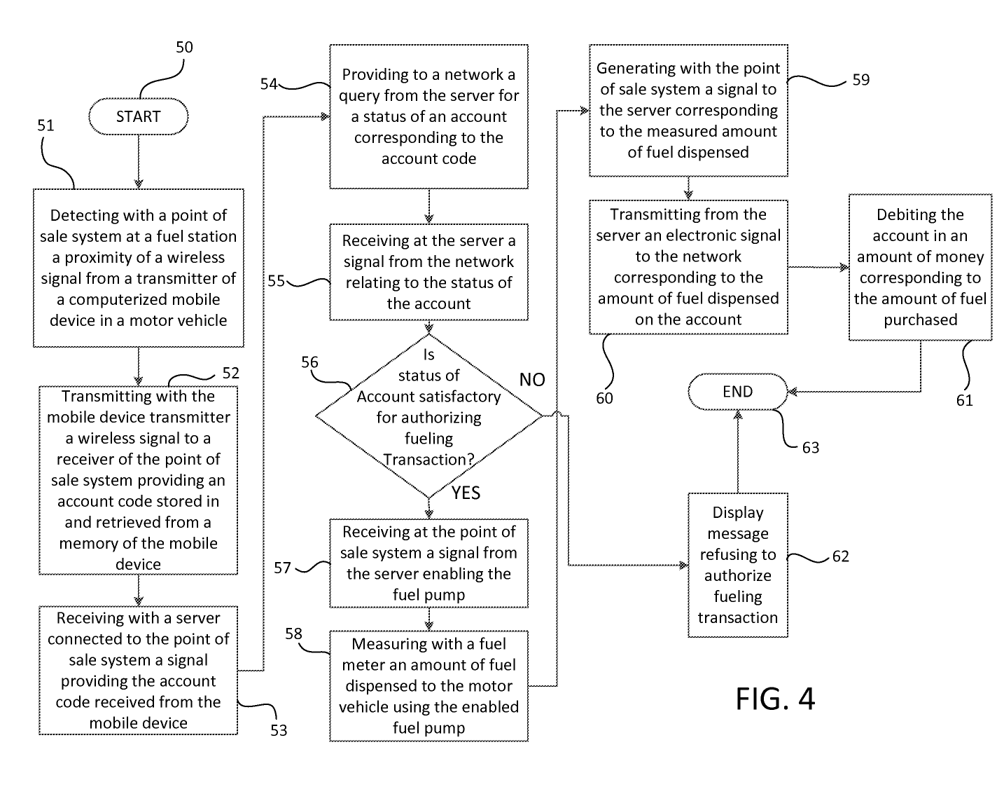

FIG. 4 is a high level flowchart illustrating an embodiment of a method and system of the present invention for enabling a fuel purchase transaction. In step 50, the method begins. In step 51, the point of sale system detects a wireless signal from a transmitter of a mobile computing device within a proximity of a fuel dispensing pump. In step 52, the mobile computing device transmitter is used to transmit a signal, to a wireless signal receiver in the point of sale system, providing an account code. In step 53, the account code is received by a fuel station server. In step 54, a query from the fuel station server to a web-based server seeks the status of the account associated with the account code. In step 55, a signal from the web-based server is received at the fuel station server indicating the status of the account associated with the account code. In step 56, a determination is made as to whether the account status is satisfactory for authorizing the fuel purchase transaction. If the account status is unsatisfactory then, in step 62, a message is displayed at the display screen/key pad notifying the account holder that the transaction is refused and the transaction is halted at step 63. If the account status is satisfactory then, at step 57, the fuel station server generates a signal to the point of sale system enabling the fuel dispensing pump. In step 58, a fuel meter is used to measure the amount of fuel dispensed and, in step 59, the point of sale system generates a signal to the server corresponding to the measured amount of fuel dispensed. In step 60, the server transmits a signal to the network (e.g., to a web-based server) providing the amount of the transaction and, in step 61, the account is debited in an appropriate amount. In step 63, the transaction is ended.

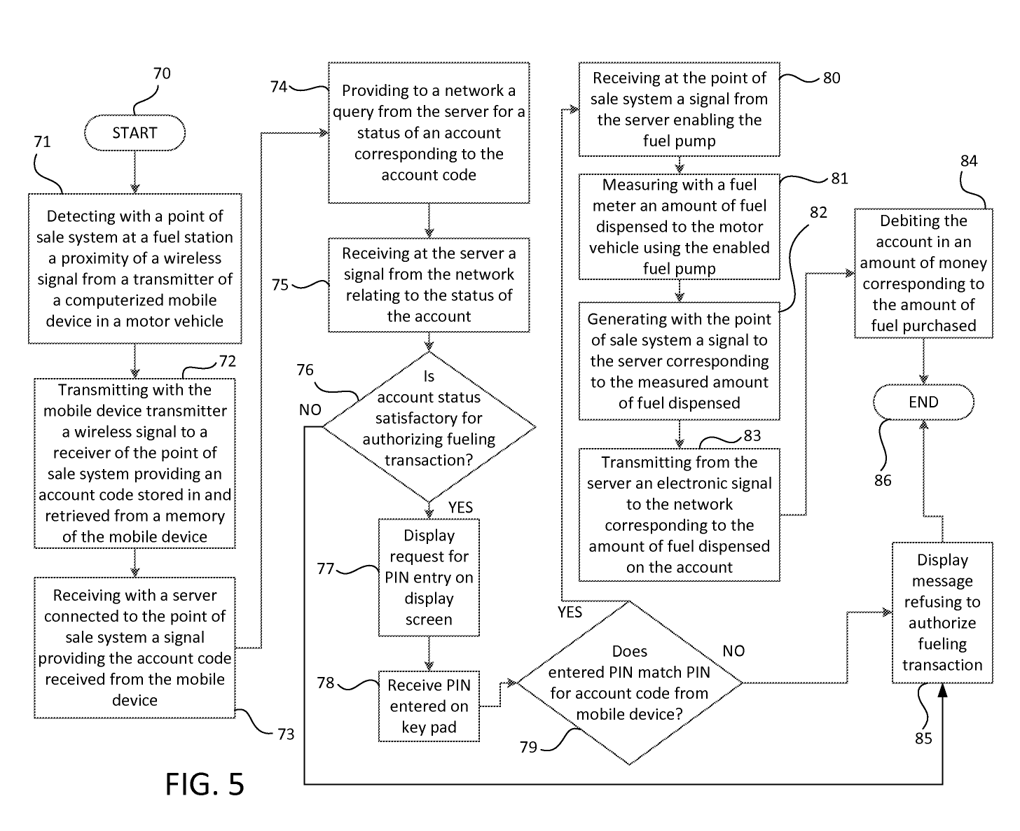

FIG. 5 is a high level flowchart illustrating an embodiment of a method and system of the present invention for enabling a fuel purchase transaction. In step 70, the method begins. In step 71, the point of sale system detects a wireless signal from a transmitter of a mobile computing device within a proximity of a fuel dispensing pump. In step 72, the mobile computing device transmitter is used to transmit a signal, to a wireless signal receiver in the point of sale system, providing an account code. In step 73, the account code is received by a fuel station server. In step 74, a query from the fuel station server to a web-based server seeks the status of the account associated with the account code. In step 75, a signal from the web-based server is received at the fuel station server indicating the status of the account associated with the account code. In step 76, a determination is made as to whether the account status is satisfactory for authorizing the fuel purchase transaction. If the account status is unsatisfactory then, in step 85, a message is displayed at the display screen/key pad notifying the account holder that the transaction is refused and the transaction is halted at step 86. If the account status is satisfactory then, at step 77, a request is displayed on a display screen for the entry of a personal identification number using a key pad. In step 78, a personal identification number is entered on the key pad and, in step 79, a determination is made as to whether the personal identification number matches a personal identification number in a database accessed by the fuel station server or the web-based server. If it is determined that the personal identification number does not match then, in step 85, a message is displayed at the display screen/key pad notifying the account holder that the transaction is refused and the transaction is halted at step 86. If it is determined that the personal identification number does match then, in step 80, a signal is sent to the point of sale system activating the fuel dispensing pump associated with the key pad from which the personal identification code was received. In step 81, the fuel dispensed using the activated fuel dispensing pump is measured using a fuel meter and, in step 82, a signal to the fuel station server is generated corresponding to the measured amount of fuel dispensed at the pump. In step 83, an electronic signal is sent from the fuel station server to the network corresponding to the measured amount of fuel dispensed and, in step 84, the account associated with the account code is debited in the amount of money corresponding to the amount of fuel dispensed, and the process ends at step 86.

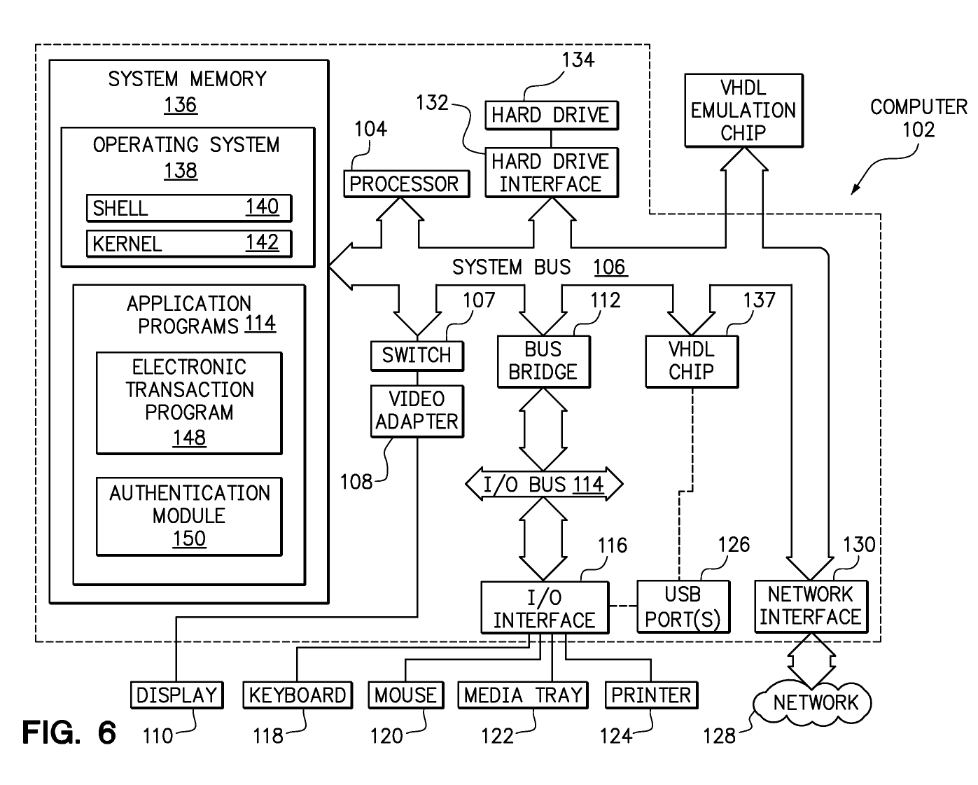

FIG. 6 is a diagram of an exemplary computing node that may be utilized in accordance with one or more embodiments of the method and system of the present invention. As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof, A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention may be described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, and/or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

FIG. 6 is a diagram of an exemplary computing node (or simply “computer”) 102 that may be utilized in accordance with one or more embodiments of the present invention. Note that some or all of the exemplary architecture, including both depicted hardware and software, shown for and within computer 102 may be implemented in the service provider computer 102 as shown in FIG. 1.

Computer 102 includes a processor unit 104 that is coupled to a system bus 106. Processor unit 104 may utilize one or more processors, each of which has one or more processor cores. A video adapter 108, which drives/supports a display 110, is also coupled to system bus 106. In one embodiment, a switch 107 couples the video adapter 108 to the system bus 106. Alternatively, the switch 107 may couple the video adapter 108 to the display 110. In either embodiment, the switch 107 is a switch, preferably mechanical, that allows the display 110 to be coupled to the system bus 106, and thus to be functional only upon execution of instructions that support the processes described herein.

System bus 106 is coupled via a bus bridge 112 to an input/output (I/O) bus 114. An I/O interface 116 is coupled to I/O bus 114. I/O interface 116 affords communication with various I/O devices, including a keyboard 118, a mouse 120, a media tray 122 (which may include storage devices such as CD-ROM drives, multi-media interfaces, etc.), a printer 124, and (if a VHDL chip 137 is not utilized in a manner described below), external USB port(s) 126. While the format of the ports connected to I/O interface 116 may be any known to those skilled in the art of computer architecture, in a preferred embodiment some or all of these ports are universal serial bus (USB) ports.

As depicted, the computer 102 is able to communicate over a network 128 using a network interface 130. Network 128 may be an external network such as the Internet, or an internal network such as an Ethernet or a virtual private network (VPN).

A hard drive interface 132 is also coupled to system bus 106. Hard drive interface 132 interfaces with a hard drive 134. In a preferred embodiment, hard drive 134 populates a system memory 136, which is also coupled to system bus 106. System memory is defined as a lowest level of volatile memory in computer 102. This volatile memory includes additional higher levels of volatile memory (not shown), including, but not limited to, cache memory, registers and buffers. Data that populates system memory 136 includes computer 102's operating system (OS) 138 and application programs 144.

The operating system 138 includes a shell 140, for providing transparent user access to resources such as application programs 144. Generally, shell 140 is a program that provides an interpreter and an interface between the user and the operating system. More specifically, shell 140 executes commands that are entered into a command line user interface or from a file. Thus, shell 140, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while shell 140 is a text-based, line-oriented user interface, the present invention will equally well support other user interface modes, such as graphical, voice, gestural, etc.

As depicted, OS 138 also includes kernel 142, which includes lower levels of functionality for OS 138, including providing essential services required by other parts of OS 138 and application programs 144, including memory management, process and task management, disk management, and mouse and keyboard management. Application programs 144 in the system memory of computer 102 may include an electronic transaction program 148 and an authentication module 150 for implementing the methods described herein.

Also stored in the system memory 136 is a VHDL (VHSIC hardware description language) program 139. VHDL is an exemplary design-entry language for field programmable gate arrays (FPGAs), application specific integrated circuits (ASICs), and other similar electronic devices. In one embodiment, execution of instructions from VMPP 148 causes the VHDL program 139 to configure the VHDL chip 137, which may be an FPGA, ASIC, or the like.

In another embodiment of the present invention, execution of instructions from VMPP 148 results in a utilization of VHDL program 139 to program a VHDL emulation chip 151. VHDL emulation chip 151 may incorporate a similar architecture as described above for VHDL chip 137. Once VMPP 148 and VHDL program 139 program VHDL emulation chip 151, VHDL emulation chip 151 performs, as hardware, some or all functions described by one or more executions of some or all of the instructions found in VMPP 148. That is, the VHDL emulation chip 151 is a hardware emulation of some or all of the software instructions found in VMPP 148. In one embodiment, VHDL emulation chip 151 is a programmable read only memory (PROM) that, once burned in accordance with instructions from VMPP 148 and VHDL program 139, is permanently transformed into a new circuitry that performs the functions needed to perform the processes of the present invention.

The hardware elements depicted in computer 102 are not intended to be exhaustive, but rather are representative components suitable to perform the processes of the present invention. For instance, computer 102 may include alternate memory storage devices such as magnetic cassettes, digital versatile disks (DVDs), Bernoulli cartridges, and the like. These and other variations are intended to be within the spirit and scope of the present invention.

The phrase “account code,” as used herein, may, but does not have to be, an account number used to identify and track an account that is owned by the user. Alternately, account code can mean a unique application identification number assigned to an installed instance of a software application on a mobile computing device, or a vehicle telematics system, to identify the software installed on the mobile computing device and to create a relationship between the installed software application and an account. Further, an account code can have an explanation and each instance of the installed software can only have one account code at any given time. It will be understood that these features can be used to provide an additional (third) level of authentication and security for the owner of the mobile computing device used in embodiments of the present invention.

As used in this application, the phrase “vehicle telematics system” means to an integrated telecommunications and information system with wireless communications capacity. These systems are sometimes referred to as in-vehicle infotainment systems, and are often integrated with entertainment systems and/or navigation systems. Vehicle telematics systems include, for example, but are not limited to, GM On-Star®, GM On-Star MyLink™, Chrysler UConnect®, Ford Sync®, Kia UVO®, Toyota Entune®, Hyundai BlueLink™ systems, and further includes other systems developed by these and other vehicle manufacturers and aftermarket component manufacturers.

The phrase “personal identification number, as used herein, does not imply any association between the number and any existing provider of credit services that may use that phrase, but instead means any passcode or password, or other sequence of characters, that can be used to confirm, verify or certify that an account code submitted through means other than the display screen/key pad 14 is being submitted by the person that owns the account.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

While the foregoing written description of the invention enable one of ordinary skill to make and use what is considered presently to be the best mode thereof, those of ordinary skill will understand and appreciate the existence of variations, combination, and equivalents of the specific embodiment, method, and example herein, The invention should therefore not be limited by the above described embodiment, method, and examples, but by all embodiments and methods within the scope and spirit of the invention as claimed.

We claim:

1. A method, comprising:
detecting, with a point of sale payment system in a frontcourt at a fuel station, a wireless signal from a transmitter of a mobile computing device in a motor vehicle;
transmitting, with the mobile computing device transmitter, a wireless signal to a receiver providing an account code stored in and retrieved from a readable memory of the mobile computing device;
receiving, with a fuel station server connected to the receiver, a signal providing the account code stored on the readable memory of the mobile computing device;
providing, to a network connected to the fuel station server, a query from the fuel station server for a status of an account corresponding to the received account code;
receiving, at the fuel station server, a signal from the network providing the status of the account;
receiving, at the point of sale system in the frontcourt of the fuel station, a signal from the fuel station server enabling a fuel dispensing pump proximal to the motor vehicle with the mobile computing device;
measuring, with a fuel meter in the frontcourt of the fuel station, an amount of fuel dispensed to the motor vehicle using the enabled fuel dispensing pump;
generating, with the point of sale system, a signal to the fuel station server corresponding to the measured amount of fuel dispensed; and
transmitting, from the fuel station server, a signal to the network corresponding to the amount of fuel dispensed.

2. The method of claim 1, further comprising:
debiting the account in an amount of money corresponding to the amount of fuel dispensed.

3. The method of claim 1, wherein transmitting, with the mobile computing device transmitter, a wireless signal to a receiver providing an account code stored in and retrieved from a readable memory of the mobile computing device comprises:
transmitting, with a transmitter of the mobile computing device, a wireless signal providing the account code retrieved from the readable memory of the mobile computing device to a receiver connected to a cellular telephone communications tower proximal to the fuel station; and
relaying, from the receiver connected to the cellular telephone communications tower, a signal providing the account code to a web-based server via the Internet.

4. The method of claim 3, wherein receiving, with a fuel station server connected to the receiver, a signal providing the account code stored on the readable memory of the mobile computing device comprises:
receiving from the web-based server, via the Internet and at the fuel station server, a signal providing the account code stored on the readable memory of the mobile computing device.

5. The method of claim 1, wherein transmitting, with the mobile computing device transmitter, a wireless signal to a receiver providing an account code stored in and retrieved from a readable memory of the mobile computing device comprises:
transmitting a wireless signal from the mobile computing device transmitter to a wireless signal receiver of a wireless fidelity system at the fuel station and connected to the fuel station server.

6. The method of claim 5, wherein receiving, with a fuel station server connected to the receiver, a signal providing the account code stored on the readable memory of the mobile computing device comprises:
receiving, from the mobile computing device transmitter, via the wireless signal receiver of the wireless fidelity system, a signal providing the account code to the fuel station server.

7. The method of claim 4, further comprising:
debiting the account in an amount of money corresponding to the amount of fuel dispensed.

8. The method of claim 6, further comprising:
debiting the account in an amount of money corresponding to the amount of fuel dispensed.

9. The method of claim 3, wherein the mobile computing device transmitter operates in a first mode to transmit a signal to a cellular telephone communications tower and in a second mode to transmit a signal to a wireless fidelity system in the frontcourt of the fuel station.

10. The method of claim 1, further comprising:
providing a display screen/key pad in the fuel station frontcourt proximal to the fuel dispensing pump to receive a personal identification number;
receiving from the display screen/key pad the personal identification number;
retrieving from a readable memory storage a personal identification number associated with the account code; and
comparing the received personal identification number to the personal identification number associated with the account code.

11. A computer program product including computer readable program code embodied on a computer readable storage medium for automating a fuel purchase transaction at a fuel station, the computer program product including:
computer readable program code for detecting, with a point of sale payment system in a frontcourt at a fuel station, a wireless signal from a transmitter of a mobile computing device in a motor vehicle;
computer readable program code for transmitting, with the mobile computing device transmitter, a wireless signal to a receiver providing an account code stored in and retrieved from a readable memory of the mobile computing device;
computer readable program code for receiving, with a fuel station server connected to the receiver, a signal providing the account code stored on the readable memory of the mobile computing device;
computer readable program code for providing, to a network connected to the fuel station server, a query from the fuel station server for a status of an account corresponding to the received account code;
computer readable program code for receiving, at the fuel station server, a signal from the network providing the status of the account;
computer readable program code for receiving, at the point of sale system in the frontcourt of the fuel station, a signal from the fuel station server enabling a fuel pump proximal to the motor vehicle with the mobile computing device;
computer readable program code for measuring, with a fuel meter in the frontcourt of the fuel station, an amount of fuel dispensed to the motor vehicle using the enabled fuel pump;
computer readable program code for generating, with the point of sale system, a signal to the fuel station server corresponding to the measured amount of fuel dispensed; and
computer readable program code for transmitting, from the fuel station server, a signal to the network corresponding to the amount of fuel dispensed.

12. The computer program product of claim 11, further comprising:
computer readable program code for debiting the account in an amount of money corresponding to the amount of fuel dispensed.

13. The computer program product of claim 11, wherein computer program product code for transmitting, with the mobile computing device transmitter, a wireless signal to a receiver providing an account code stored in and retrieved from a readable memory of the mobile computing device comprises:
computer program product code for transmitting, with a transmitter of the mobile computing device, a wireless signal providing the account code retrieved from the readable memory of the mobile computing device to a receiver connected to a cellular telephone communications tower proximal to the fuel station; and
computer program product code for relaying, from the receiver connected to the cellular telephone communications tower, a signal providing the account code to a web-based server via the Internet.

14. The computer program product code of claim 13, wherein computer program product code for receiving, with a fuel station server connected to the receiver, a signal providing the account code stored on the readable memory of the mobile computing device comprises:
computer program product code for receiving from the web-based server, via the Internet and at the fuel station server, a signal providing the account code stored on the readable memory of the mobile computing device.

15. The computer program product code of claim 11, wherein transmitting, with the mobile computing device transmitter, a wireless signal to a receiver providing an account code stored in and retrieved from a readable memory of the mobile computing device comprises:
computer program product code for transmitting a wireless signal from the mobile computing device transmitter to a wireless signal receiver of a wireless fidelity system at the fuel station and connected to the fuel station server.

16. The computer program product code of claim 15, wherein receiving, with a fuel station server connected to the receiver, a signal providing the account code stored on the readable memory of the mobile computing device comprises:
computer program product code for receiving, from the mobile computing device transmitter, via the wireless signal receiver of the wireless fidelity system, a signal providing the account code to the fuel station server.

17. The computer program product code of claim 14, further comprising:
computer program product code for debiting the account in an amount of money corresponding to the amount of fuel dispensed.

18. The computer program product code of claim 16, further comprising:
computer program product code for debiting the account in an amount of money corresponding to the amount of fuel dispensed.

19. The computer program product code of claim 13, wherein the mobile computing device transmitter operates in a first mode to transmit a signal to a cellular telephone communications tower and in a second mode to transmit a signal to a wireless fidelity system in the frontcourt of the fuel station.

20. The computer program product of claim 11, further comprising:
computer program product code for providing a display screen/key pad in the fuel station frontcourt proximal to the fuel dispensing pump to receive a personal identification number;
computer program product code for receiving from the display screen/key pad the personal identification number;
computer program product code for retrieving from a readable memory storage a personal identification number associated with the account code; and
computer program product code for comparing the received personal identification number to the personal identification number associated with the account code.
